(19) United States
(12) Patent Application Publication
(10) Pub. No.: US 2025/0003711 A1
(43) Pub. Date: Jan. 2, 2025

(54) ADDITIVE METAL RIFLE SYSTEMS AND MANUFACTURING METHODS

(71) Applicants: James Phillip Renick, Las Vegas, NV (US); Brent Jarboe, Elizabethtown, KY (US)

(72) Inventors: James Phillip Renick, Las Vegas, NV (US); Brent Jarboe, Elizabethtown, KY (US)

(21) Appl. No.: 18/761,246

(22) Filed: Jul. 1, 2024

Related U.S. Application Data
(60) Provisional application No. 63/524,571, filed on Jun. 30, 2023.

(51) Int. Cl. F41A 21/48; B33Y 80/00; F41A 3/66; F41A 17/38

(52) U.S. Cl. CPC F41A 21/48; B33Y 80/00; F41A 3/66; F41A 17/38

(57) ABSTRACT

A rifle system and methods for construction thereof is provided. The rifle system is formed using alternative production methods, such as advanced additive manufacturing (“AM”) technologies—also called 3D printing. Also included is an improved trigger housing, an improved bolt hold detent system configured to be operated ambidextrously, an improved magazine-well, an improved trunnion, and an ambidextrous release assembly.

### CROSS-REFERENCE TO RELATED APPLICATIONS

This application claims priority to U.S. Provisional Application Ser. No. 63/524,571, filed Jun. 30, 2023, the entire disclosures of which are incorporated herein by reference.

### FIELD OF THE INVENTION

The present invention relates generally to firearms. Specifically, the present invention relates to additive metal rifles systems and methods for manufacturing additive metal rifles.

### BACKGROUND

The G36 rifle platform was first prototyped in the early 90s as a cold war era replacement for the aging roller rocker G3k and G3A1. The G36 is made of plastic and light polymers to create a lightweight assault rifle. Use of plastic and light polymers in firearm construction, especially in the receiver body, creates durability and tolerance issues. These firearms also wear down quickly, especially in heat, and can be difficult to service or repair.

The scope of the G36's operation was to be used in cold weather climates, such as for potential battles between the USSR and NATO block countries. Therefore, the G36 design is based on German and NATO requirements of the cold war, which are now decades out of date. The design is for cold climate, and low cycle rates of rounds fired, or 3-5 magazines in full-auto. The shortcomings of the plastic and light polymer construction were not felt as strongly in these conditions. But today's typical war fighter operates in 100-degree heat, extreme altitudes (whether high or low), and in sand and mountains, usually in the middle east or Afghanistan, where these shortcomings become highly problematic.

The construction of the original G36 rifle was only achievable by means of injection molding. No other type of standard grade manufacturing process could work to create the main receiver body formation. Therefore, the original G36 is made from plastic injection molded Nylon66 which overheats and becomes weak allowing the “potted” cast iron trunnion unit to build rotating latency, making the firearm inaccurate. The plastic G36 started to fail in typical modern war conditions rapidly. In fact, a report released by the German Fraunhofer Ernst Mach Institut and Wehrtechnische Dienststelle in 2015 observed the hit rate of the predominantly plastic G36 weapon drops down to a mere 7% at 100 meters when the temperature increases by 30° C. or more. A far cry from the German Bundeswehr required hit rate of 90% at that distance. Such issues are nearly ubiquitous with plastic firearms. Nonetheless, many firearms have continued to be made from plastic due to the low cost and ease of production.

In addition to the problematic materials used in its construction, the G36 has many other downsides. The trigger housing/fire control of the G36 is proprietary to the manufacturer, rather than using NATO standards. Despite being labeled as a “modular rifle system,” the original G36 only used its own special 5.56 magazine rather than a standard STANAG NATO m16 mag. Furthermore, the grip is not interchangeable. And the rifle is not serviceable by the normal soldier. Even further, the bolt detent is a safety obstruction in the down position while wearing gloves. The detent only functions when the bolt is open and needed to be closed. Creating another safety issue. The gas block is not adjustable for suppressed or maritime environments leaving more malfunctions to exist. The G36 has a non-NATO weapons optics system with a mounting area not locked in place. Allowing for no real Minute of Angle (“MOA”) or accuracy basis to be established. This interface between the plastic receiver body and the dual optic carry handle creates a weak point on the firearm. Finally, the aging G36 is difficult to service and there is a lack of parts in stock.

It would be advantageous to provide a new rifle that solves the problems of the G36 platform and similar weapons platforms. It would be advantageous to provide a new rifle capable of performing in modern combat settings. To that end, it would be advantageous to provide a rifle constructed from more durable metal materials. Additionally, it would be advantageous to provide a method for constructing such rifles in an efficient and cost-effective manner.

### SUMMARY

The instant invention includes a rifle system and methods for construction thereof. The rifle system is formed using alternative production methods, such as advanced additive manufacturing (“AM”) technologies—also called 3D printing. In some embodiments, the rifle system is a 5.56 NATO caliber, gas-piston, semi-automatic rifle. Some embodiments of the present invention include an improved trigger housing. Some embodiments of the present invention include an improved bolt hold detent system configured to be operated ambidextrously. Some embodiments of the present invention include an improved magazine-well. Some embodiments of the present invention include an improved trunnion. Some embodiments of the present invention include a ambidextrous release assembly.

In some embodiments, the AM technologies facilitates formation of components that are thinner, stronger, more balanced, or otherwise improved over similar components formed using traditional processes.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention and various features thereof.

### BRIEF DESCRIPTION OF THE DRAWINGS

A preferred embodiment of the invention, illustrative of the best mode in which the applicant has contemplated applying the principles, is set forth herein and is shown in the drawings/exhibits.

FIG. 1 is a perspective view of a rifle of the present invention according to some embodiments.

FIG. 2 is a right side view of the rifle of FIG. 1.

FIG. 3 is a left side view of the rifle of FIG. 1.

FIG. 4 is a rear view of the rifle of FIG. 1.

FIG. 5 is a front view of the rifle of FIG. 1.

FIG. 6 is a top view of the rifle of FIG. 1.

FIG. 7 is a bottom view of the rifle of FIG. 1.

FIG. 8 is a perspective view of a receiver body of the rifle of FIG. 1.

FIG. 9 is a right side view of the receiver body of FIG. 8.

FIG. 10 is a left side view of the receiver body of FIG. 8.

FIG. 11 is a rear view of the receiver body of FIG. 8.

FIG. 12 is a front view of the receiver body of FIG. 8.

FIG. 13 is a top view of the receiver body of FIG. 8.

FIG. 14 is a bottom view of the receiver body of FIG. 8.

FIG. 15 shows the ambidextrous magazine release assembly according to some embodiments of the present invention.

FIG. 16 shows the ambidextrous magazine release assembly of FIG. 15 at a slightly rotated angle.

FIG. 17 is a top view of the ambidextrous magazine release assembly of FIG. 15.

FIG. 18 is a perspective view of a trunnion assembly according to some embodiments of the present invention.

FIG. 19 is a right side view of the trunnion assembly of FIG. 18.

FIG. 20 is a left side view of the trunnion assembly of FIG. 18.

FIG. 21 is a rear view of the trunnion assembly of FIG. 18.

FIG. 22 is a front view of the trunnion assembly of FIG. 18.

FIG. 23 is a top view of the trunnion assembly of FIG. 18.

FIG. 24 is a bottom view of the trunnion assembly of FIG. 18.

FIG. 25 is a right side view of a receiver assembly according to some embodiments of the present invention, the receiver assembly including the receiver body of FIG. 8, the ambidextrous magazine release assembly of FIG. 15, and the trunnion assembly of FIG. 18.

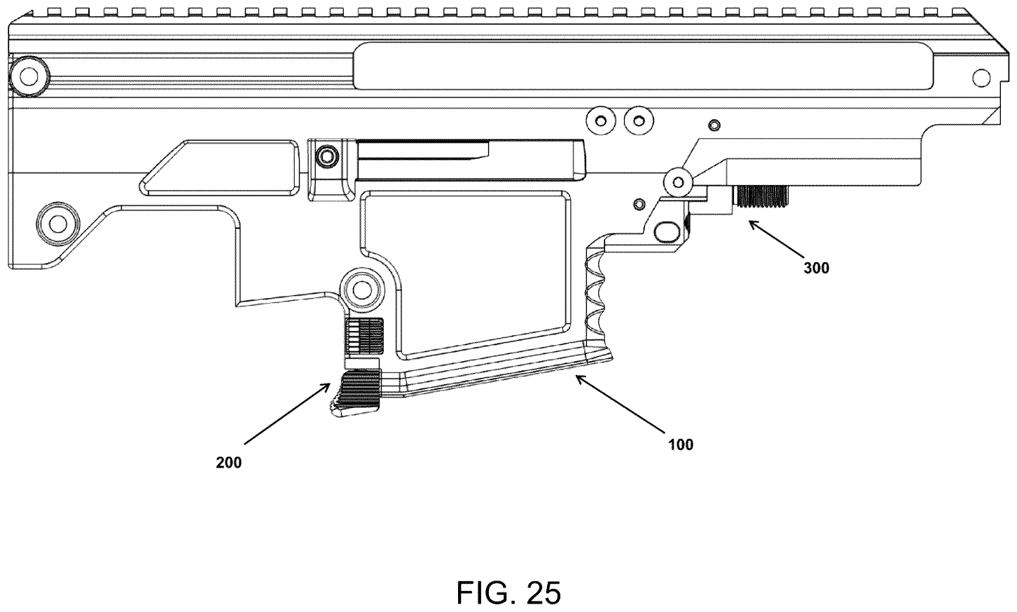

FIG. 26 is a left side view of the receiver assembly of FIG. 25.

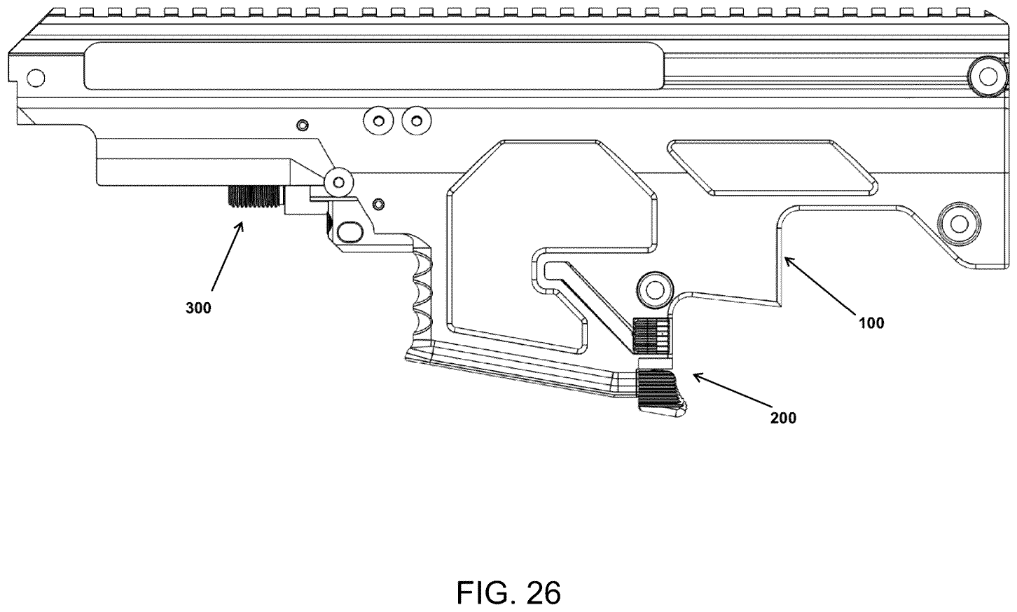

FIG. 27 is a partially exploded view of the receiver assembly of FIG. 25 from a right side perspective view.

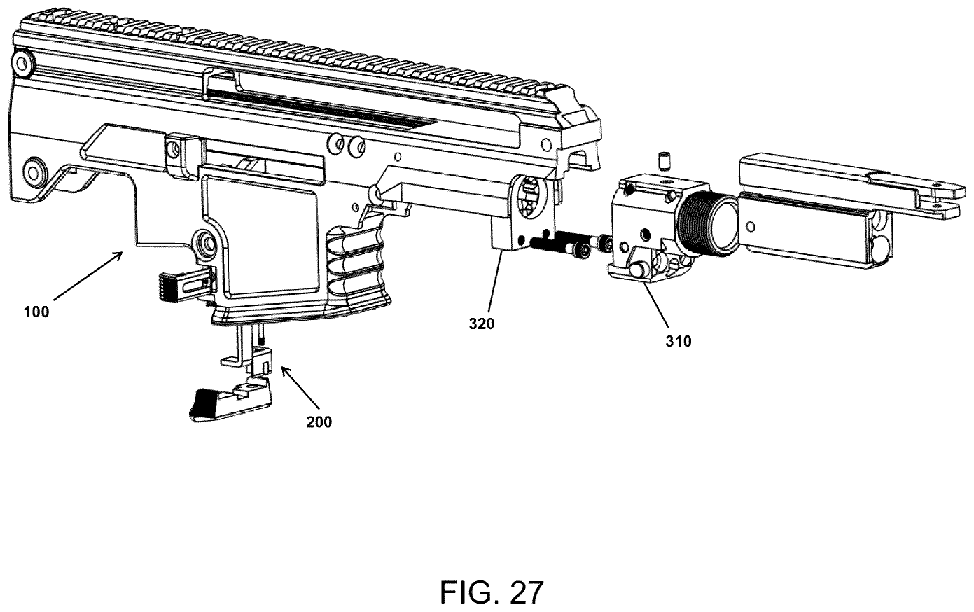

FIG. 28 is a partially exploded view of the receiver assembly of FIG. 25 from a left side perspective view.

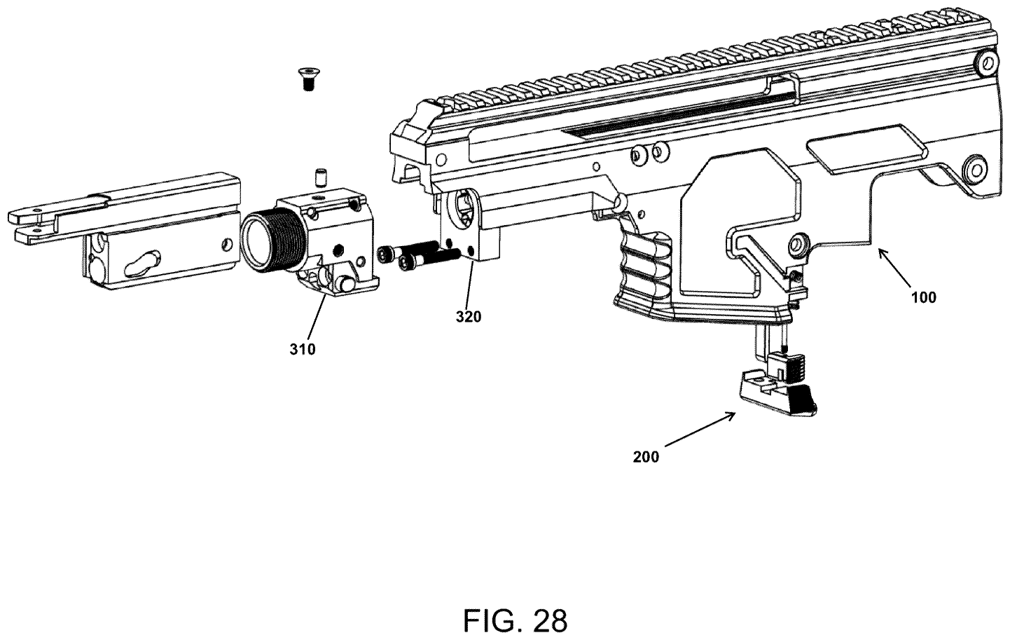

### DETAILED DESCRIPTION

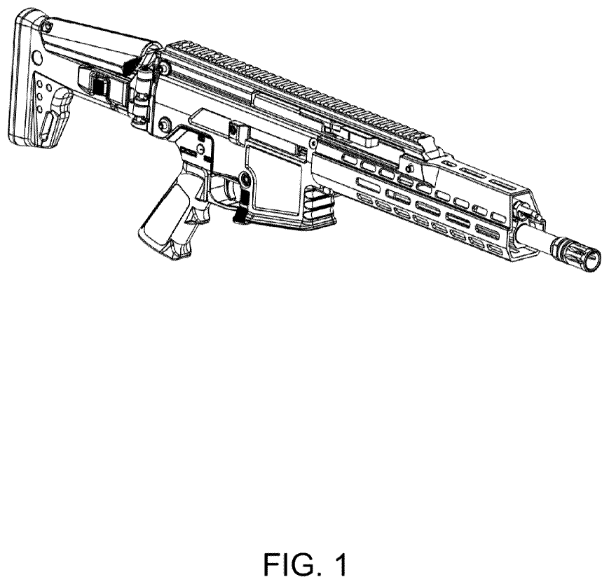

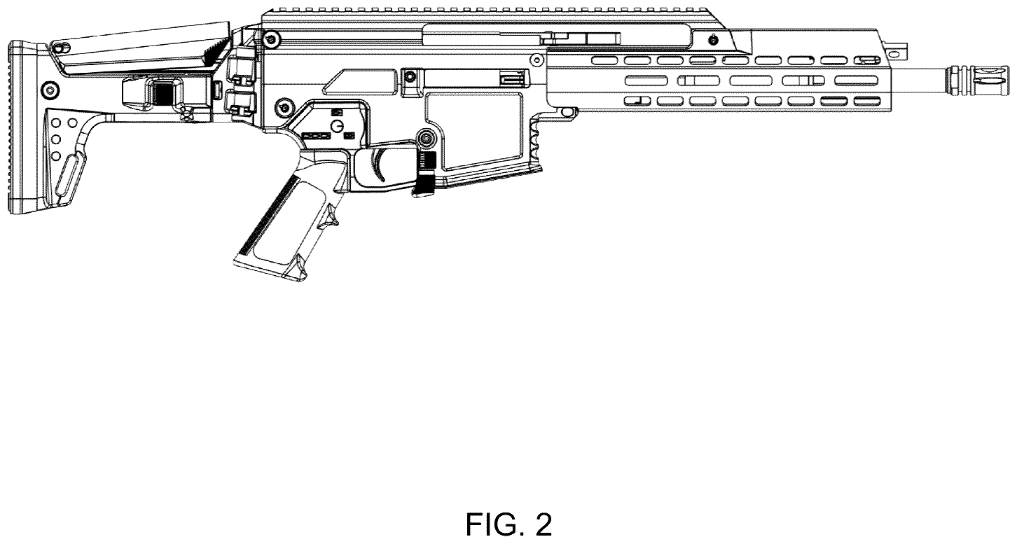

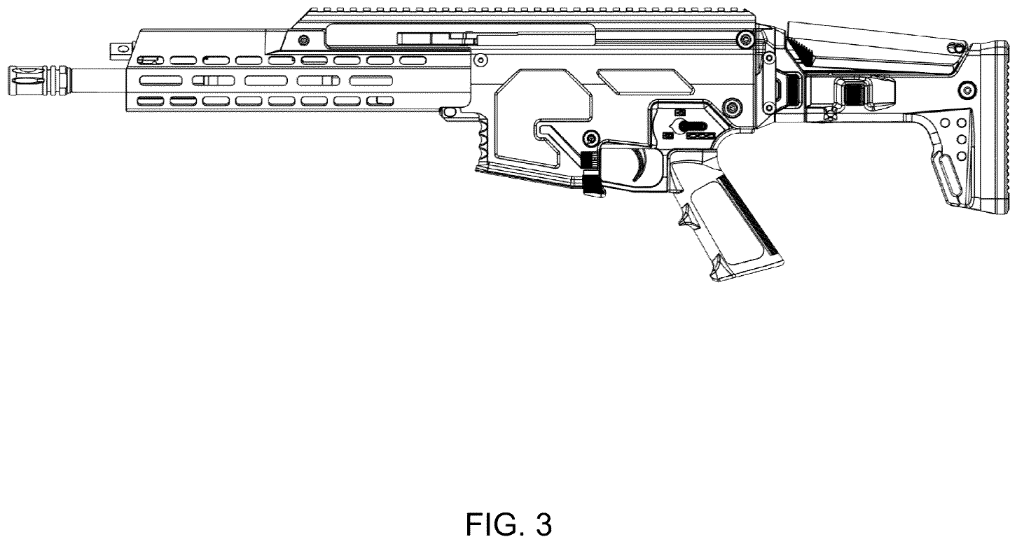

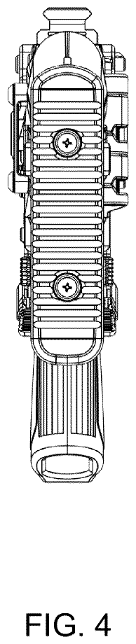

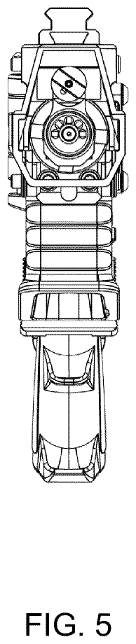

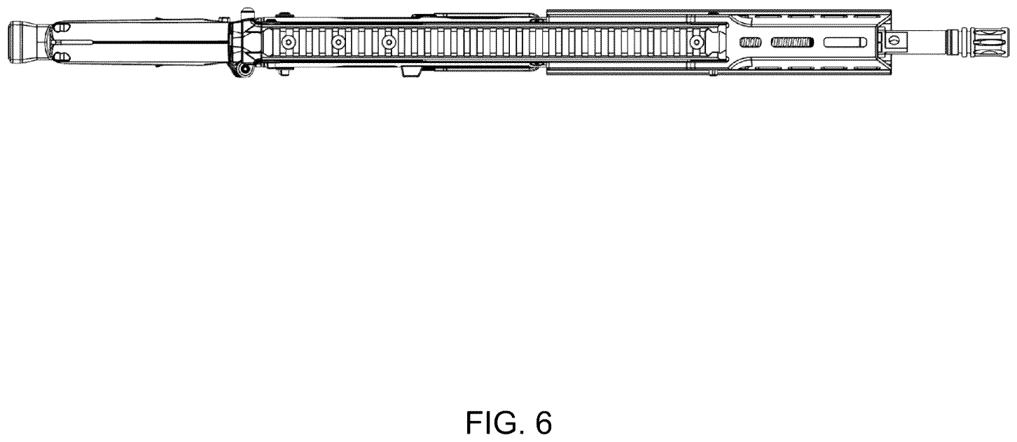

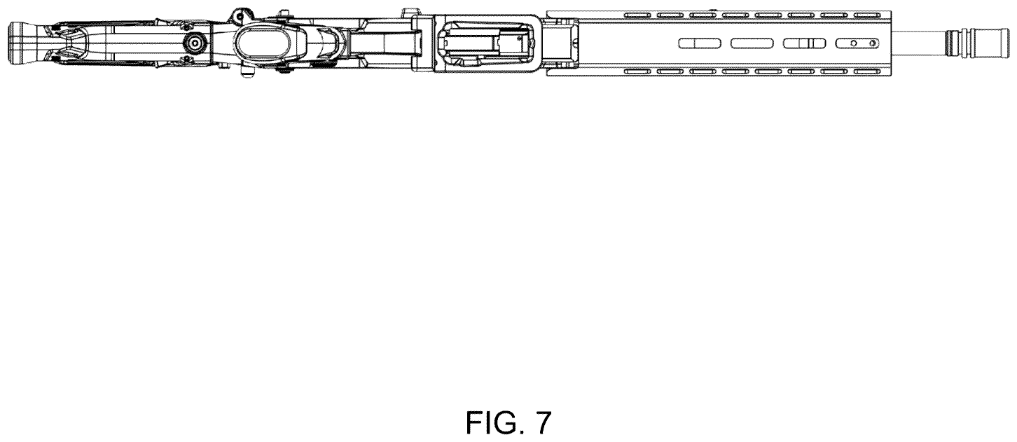

An exemplary embodiment of the instant invention includes an additive metal rifle system and methods for construction thereof. As seen in FIGS. 1-7, in some embodiments, the rifle is a 5.56 NATO caliber, gas-piston, semi-automatic rifle.

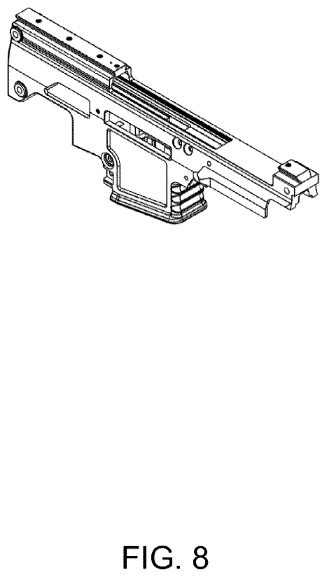

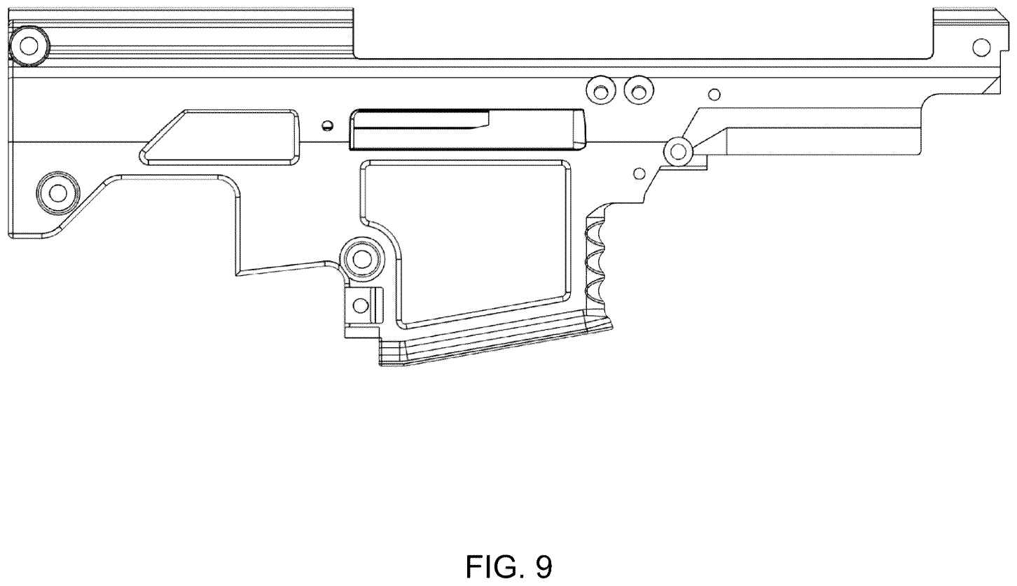

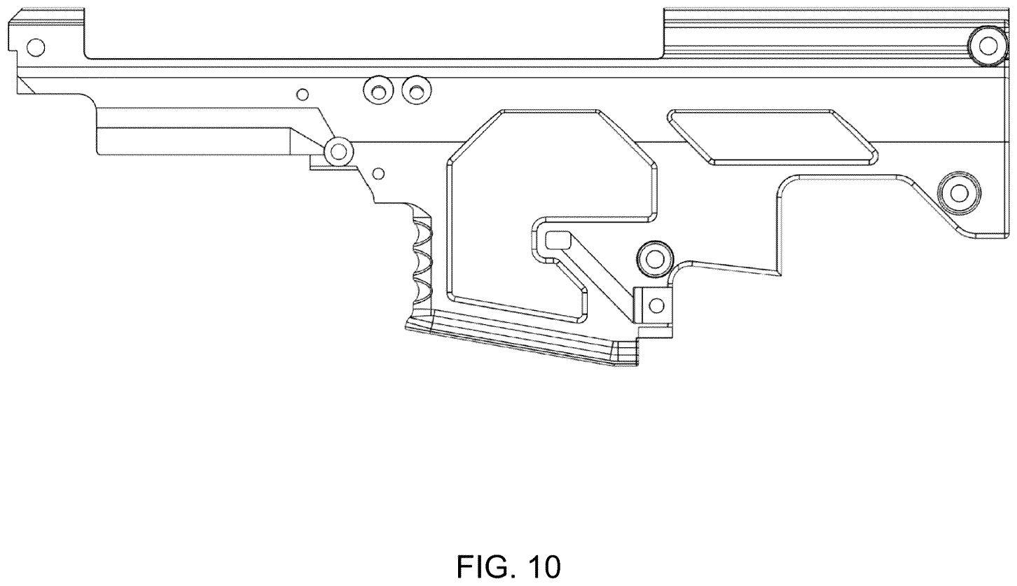

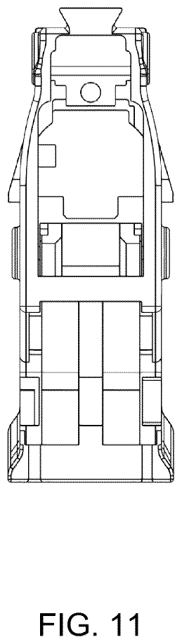

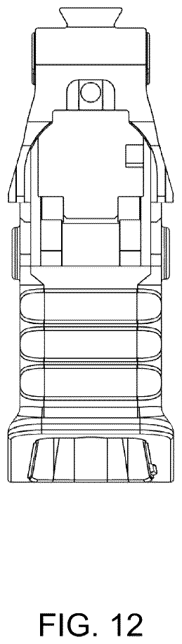

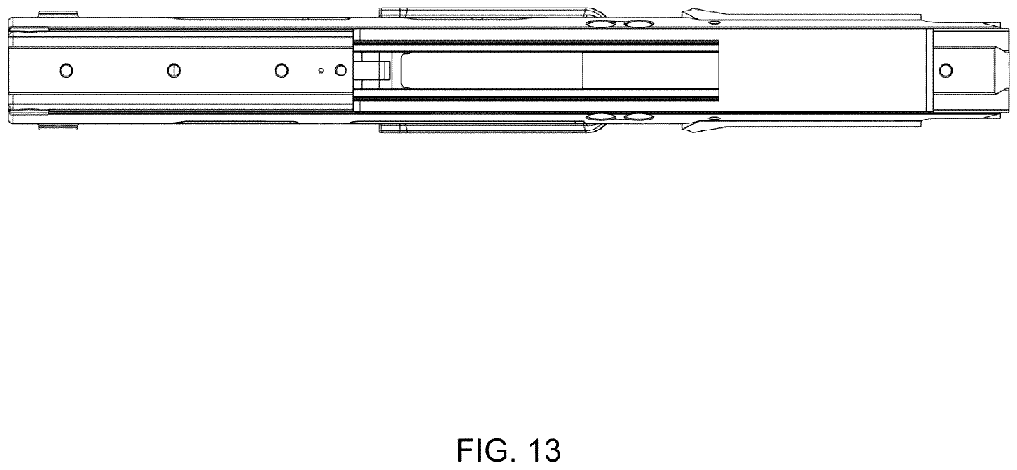

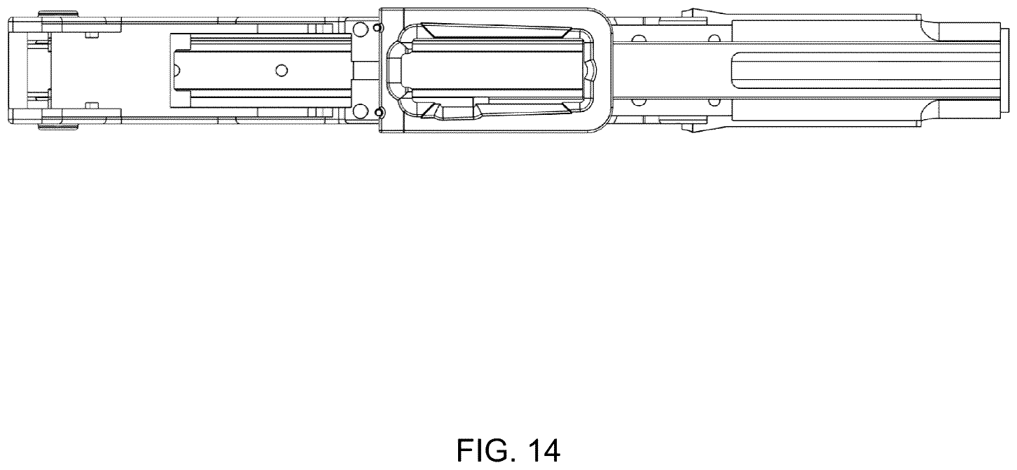

Some embodiments of the present invention include a receiver body and a method of forming the same. An exemplary receiver body of some embodiments is shown in FIGS. 8-14 In some embodiments, the receiver body is 3D printed with additive metal, such as Additive Powder A6061-RAM2C. The additive metal is hundreds of times stronger and heat resistant than Nylon6060. Moreover, the additive metal facilitates formation of components that are several times thinner in many areas, and a firearm that is more evenly balanced, and near 1 Minute of Angle (“MOA”) in accuracy. In some embodiments, the receiver body of the present invention is a single piece, rather than three pieces needed in existing platforms.

In some embodiments, the receiver body is 3D printed on top of a build plate. In some such embodiments, the receiver body is 3D printed at an angle relative to the build plate, such as an angle that minimizes or eliminates post-build machining that is otherwise required on critical surfaces. In some embodiments, critical surfaces include the bolt carrier interface surfaces, the magazine guide surfaces, and the cam pin controlling surfaces. In some embodiments, these surfaces need be free of support, which is achieved without extra machining due to the angled 3D printing.

Some embodiments of the present invention include a magazine-well adapted to be a large stress area capable of withstanding massive impact loads, in addition to functioning as a fighting impact surface. In some embodiments, this area is a single, unitary piece, which greatly increases the entire system's overall strength and operational life span. In some embodiments, the magazine-well is configured to use NATO STANAG 5.56 NATO magazine type, which creates an advantage over platforms such as the G36 that require proprietary magazines. In some embodiments, the magazine ejection interface mechanisms are located on both sides of the receiver body for ambidextrous operation. In some embodiments, the magazine ejection parts are also configured to be compatible with NATO AR platform standards. In some embodiments, the “female” side is “belled” for operational advantage when fast loading under stress.

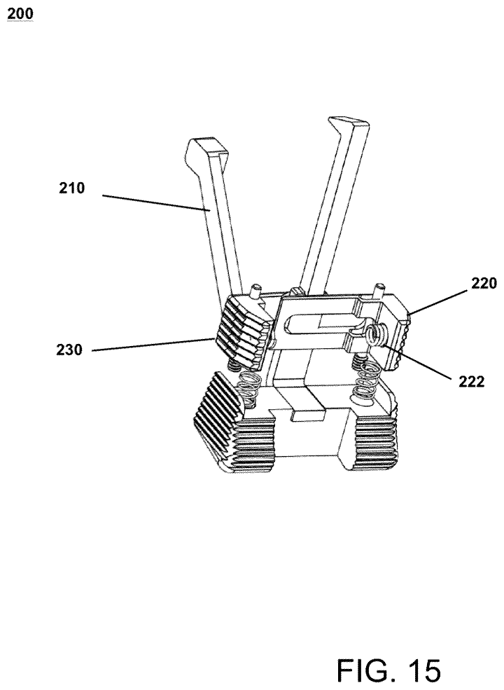

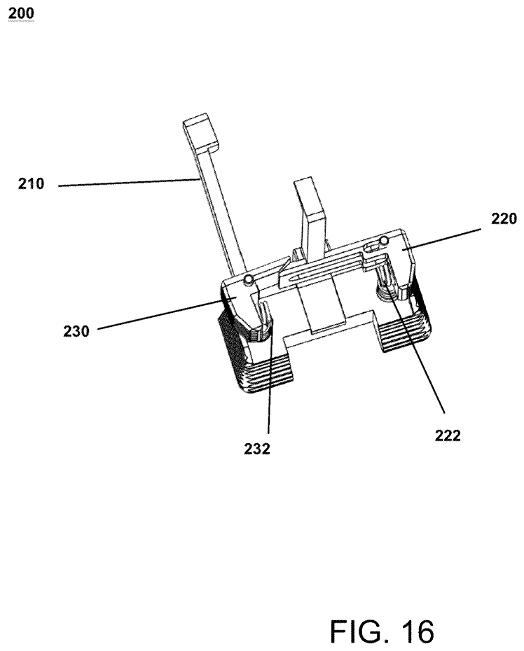

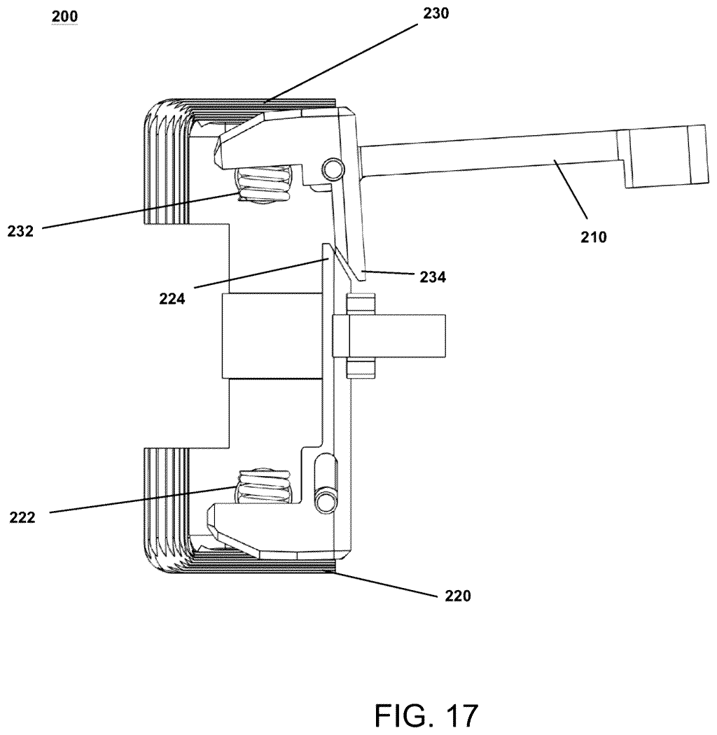

Some embodiments include a release assembly 200. In some embodiments, the release assembly 200 is a High Accuracy Anti Material Rifle (HAAMR) ambidextrous magazine release assembly. In some embodiments, such as those shown in FIGS. 15-17, the release assembly 200 includes a magazine catch plate 210, a right magazine release button 220, and a left magazine release button 230. In some such embodiments, attachment pins are utilized to attach the magazine catch plate to the left magazine release button. In some embodiments, pivots pins are utilized in connection with the magazine catch plate and right magazine release button. In some embodiments, a pocket in the magazine receives the catch plate and the catch plate holds the magazine in place. A right magazine release spring 222 is in communication with the right magazine release button 220, and left magazine release spring 232 is in communication with the right magazine release button 230. In some such embodiments, the force of the release springs keeps the release buttons in the latched state. In some embodiments, such as FIG. 17 the magazine release buttons 220 and 230 have opposing angled noses in communication with each other—the left magazine release button nose 224 and right magazine release button nose 234.

In some embodiments, in a “latched state,” the right magazine release button 220 is naturally biased outward away from the receiver body 100 and the left magazine release button 230 is naturally biased rotationally inward towards the interior of the magazine housing. In the latched state, the right magazine release button 220 is constrained by the receiver body 100 to operate only linearly whereas the left magazine release button 230 is constrained by the receiver body on both sides to operate rotationally within a predetermined arc. In some such embodiments, the left magazine release button 230 is connected to the magazine catch plate 210 such that rotating of the left magazine release button also rotates the magazine catch plate away from the magazine (allow for release of the magazine). In some embodiments, the catch plate fits into the left magazine release button and is held in place by a single pivot pin. Therefore, no additional components are required.

In such embodiments, when the right magazine release button 220 is engaged/depressed by the operator, it slides linearly towards the interior of the assembly where the angled nose contacts the angled nose of the left magazine release button 230. The angled surfaces direct the left magazine release button 230 (attached to the magazine catch plate 210) to rotate towards the exterior of the assembly, which would result in moving the magazine catch plate away from the magazine and thus releasing the magazine. Correspondingly, depressing only the left magazine release button 230 results in no movement of the right magazine release button 220 (as it is biased outward) but does result in the outward rotation of the magazine catch plate 210, releasing the magazine. Therefore, pressing of either button by operator will result in the release of the magazine. Furthermore, when the operator releases either button, the assembly returns to the latched condition as a result of their respective biasing springs 222 and 232 forcing them back.

In some embodiments, the nose ends of both the right and left magazine release buttons 220 and 230 overlap during actuation of the right magazine release button 220. The left magazine release button 230 and magazine catch plate 210 rotate clockwise (outwardly) to release the magazine. If instead the left magazine release button 230 is actuated, the rotation takes place but the right magazine release button 220 does not come into contact as it is biased away from the left magazine release button 230. In either event, the magazine is released.

In some embodiments, the structure of the right and left magazine release buttons are mirrored such that the right magazine release button and left magazine release button switch structure and form. Therefore, in such embodiments, in a “latched state,” the left magazine release button is naturally biased outward away from the receiver body and the right magazine release button is naturally biased rotationally inward towards the interior of the magazine housing. In the latched state, the left magazine release button is constrained by the receiver body to operate only linearly whereas the right magazine release button is constrained by the receiver body on both sides to operate rotationally within a predetermined arc.

Some embodiments of the present invention include a trigger housing adapted for use with “AR/M16” ergonomics and with the ability to use any off the shelf commercial or mil-spec “AR/M16” trigger pack or parts. Accordingly, operators do not have to be retrained on a new proprietary fire selection method or how to service the weapon trigger system.

Some embodiments of the present invention include a bolt hold detent system configured to be operated ambidextrously with either left- or right-hand index fingers. Either hand has the ability to send the bolt forward or to make the bolt stay open. In some embodiments, the system is configured to work with NATO standard handgrips or any universal grip type on the market. In some embodiments, the trigger housing is printed out of super lightweight high-strength porous aluminum AM powders.

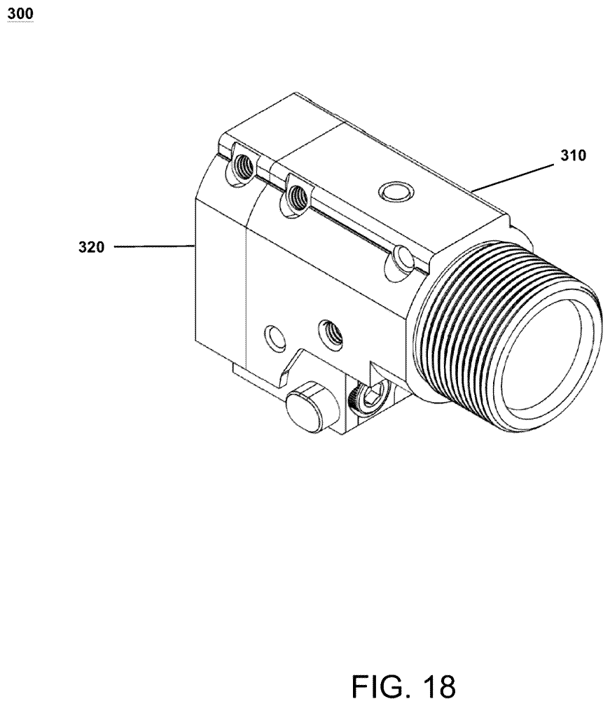

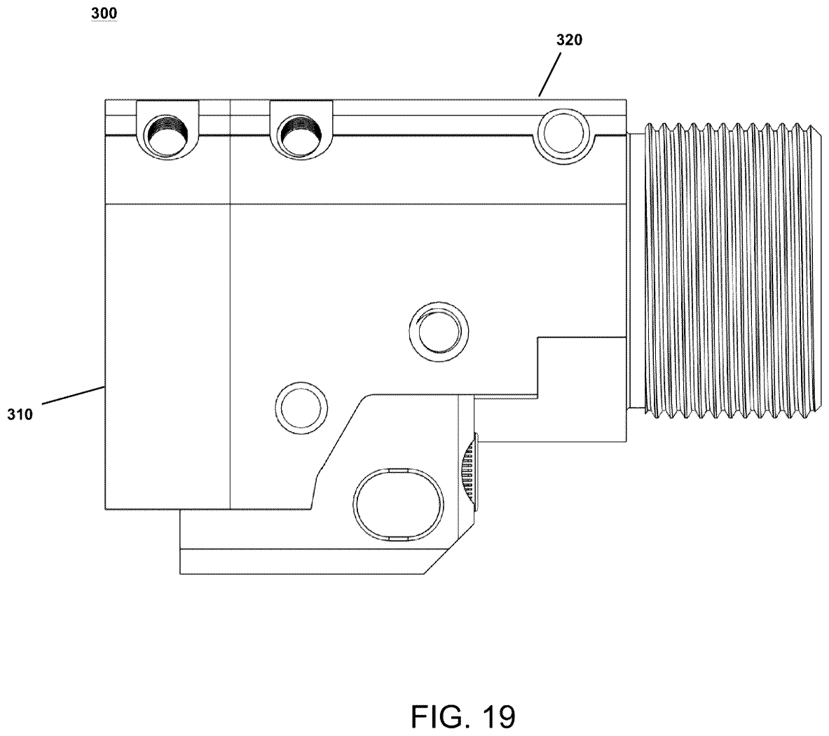

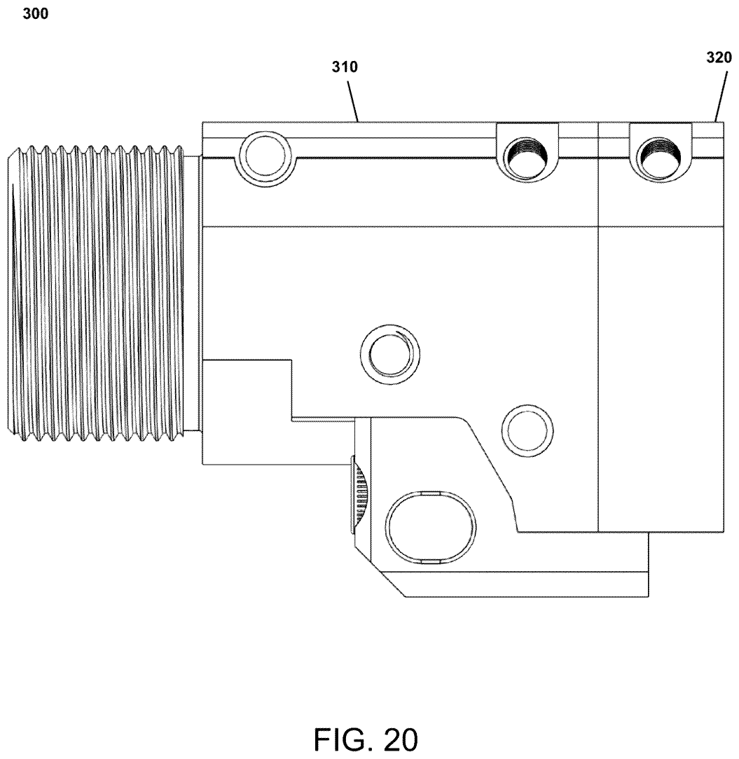

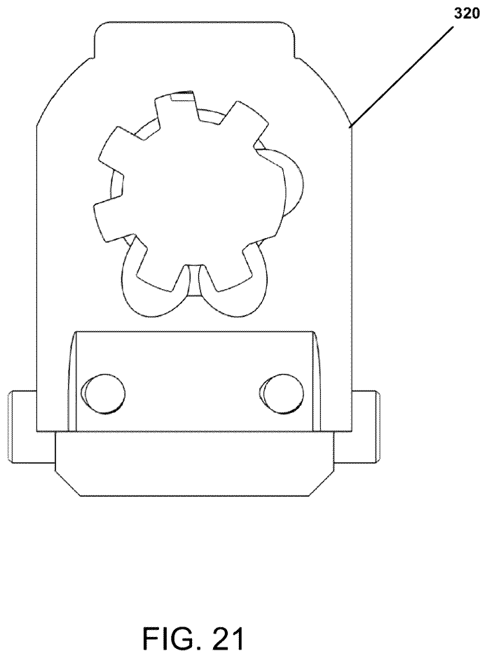

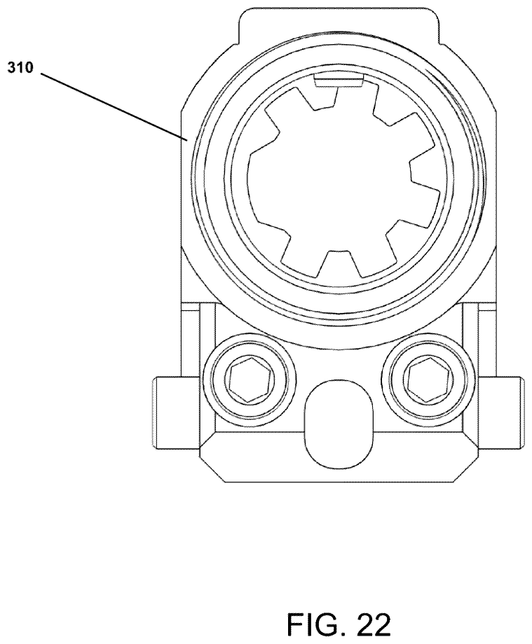

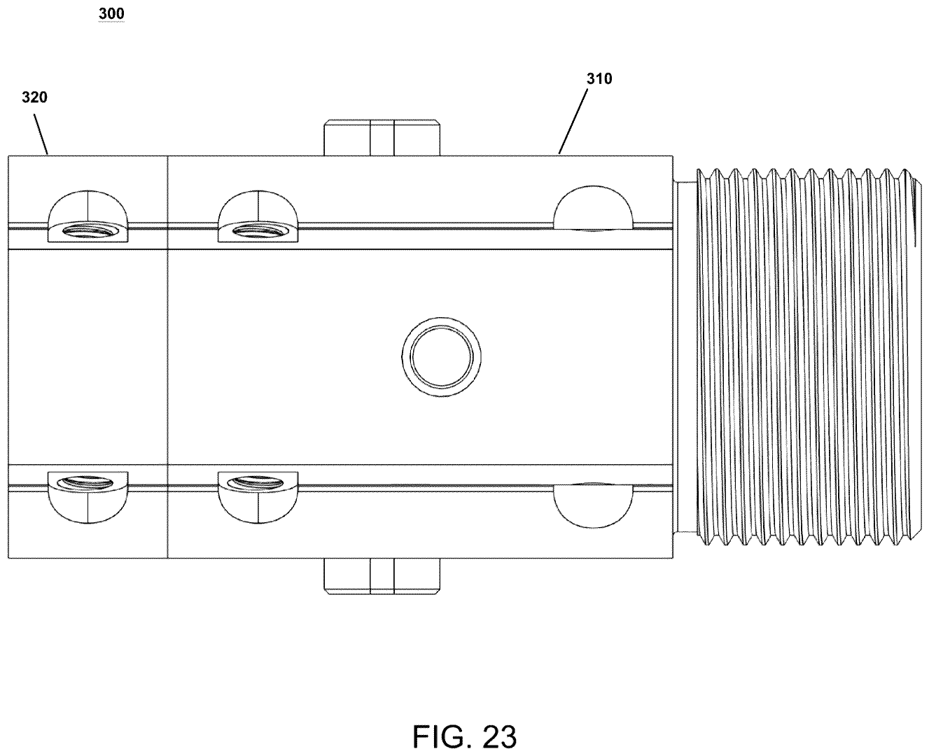

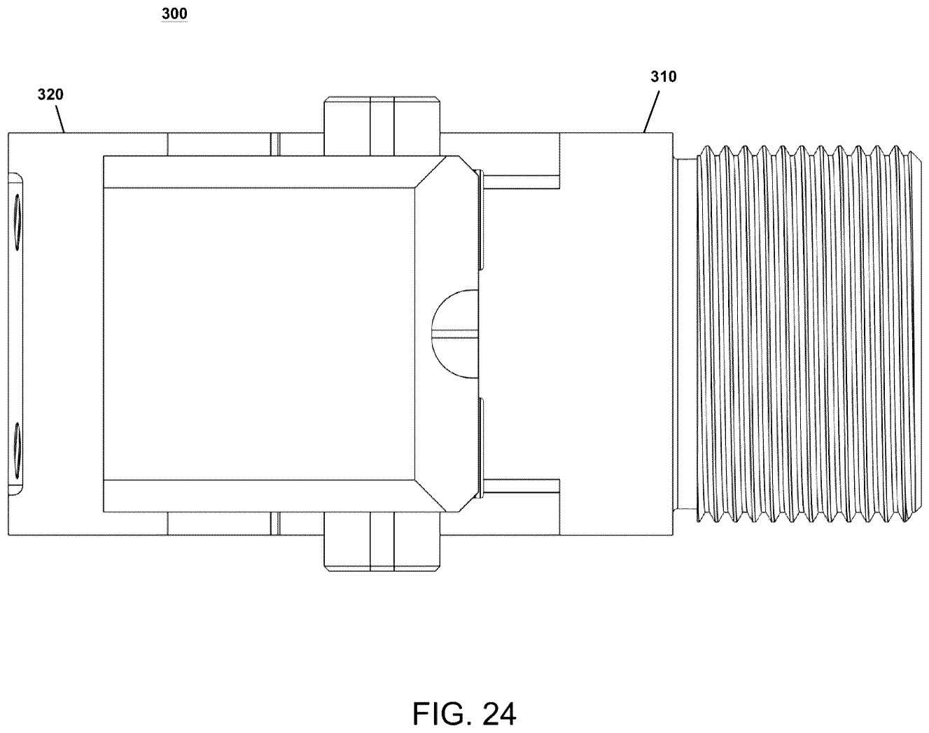

As shown in FIG. 18-24, some embodiments include a multi-piece trunnion assembly 300. Some such embodiments include a trunnion block 310. In some such embodiments, upper and lower portions of the trunnion block 310 are the two distinct parts. In some embodiments, the trunnion assembly 300 includes a trunnion plate 320. In some embodiments, one or more components of the trunnion assembly are formed using additive metal, such as by components printed out of an AM equivalent to 8620 tool steel. In some such embodiments, this design change coupled with the AM composition greatly out passes any other metal type or process to be used on any weapon platform in the world.

Some embodiments of the present invention include a receiver body with print pin locations to accept an ACR stock to be adapted as an OEM. The “ACR” universal stock is the most widely accepted and desired ergonomic stock unit.

In some embodiments, the present invention facilitates cleaning, maintaining, repairing, and reconfiguring the same. In some such embodiments, various components of the present invention, such as a barrel, the trunnion block, the trunnion plate, a bolt head, or the lake are readily removable and replacable, thereby facilitating repairing or reconfiguring the firearm. In some embodiments, reconfiguring the firearm comprises reconfiguring the firearm to handle different ammunition, such as ammunition of a different caliber. In some embodiments, reconfiguring the firearm from a first caliber to a second caliber comprises removing and replacing a first barrel and a first bolt head with a second barrel and a second bolt head, respectively. In some such embodiments, depending on the first and second calibers and the dimensions of the trunnion block and the trunnion plate, a first trunnion plate and a first trunnion block is used with each caliber configuration. In other such embodiments, one of the first trunnion plate and the first trunnion block is replaced with a respective second trunnion plate or second trunnion block, as applicable. In still other such embodiments, each of the first trunnion plate and the first trunnion block is replaced with a respective second trunnion plate and second trunnion block. In some embodiments, reconfiguration of the firearm is accomplished without replacing the barrel and/or without replacing the bolt head.

It will be appreciated that the systems and methods herein include and are adaptable to different caliber weapons. In some embodiments, this includes M5 standards, the 6.8×51 caliber standard used by the U.S. Army, caliber standards used in the U.S. Army's “Spear” project, and the 7.62×51 caliber standard. Notwithstanding the above, the systems and methods herein include and are adaptable to the manufacture of smaller and larger caliber weapons and receivers.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention and various features thereof.

What is claimed is:

1. A firearm comprising:
a single piece receiver body formed with additive metal during an additive material process, the receiver body defining a horizontal channel and a mag well extending vertically therefrom;
a barrel extending from the horizontal channel of the receiver body; and
a multi-piece trunnion assembly for securing said barrel to said receiver body, said trunnion assembly being positioned at least partially within said horizontal channel of said receiver body,
wherein said trunnion assembly comprises a trunnion plate and a trunnion block selectively secured therewith.

2. The firearm of claim 1, further comprising:
a bolt head engaged with said trunnion plate; and
a retaining nut securing said barrel to said trunnion block.

3. The firearm of claim 2, wherein said trunnion plate is coupled directly to said receiver body, wherein said trunnion block is coupled directly to said receiver body, and wherein said trunnion block and said trunnion plate are coupled directly to each other.

4. The firearm of claim 2, wherein said trunnion block is formed with additive metal during an additive material process.

5. The firearm of claim 2, further comprising:
first and second magazine release buttons coupled to said receiver body and positioned on respective first and second sides of the firearm to facilitate selective independent user engagement therewith, each of said first and second magazine release buttons being moveable between respective engaged and disengaged configurations; and
a magazine catch plate extending from said first magazine release button and being moveable from a retaining position to a retracted position by moving said first magazine release button from its disengaged configuration to its engaged configuration,
wherein holding said second magazine release button in its engaged configuration inhibits said first magazine release button from moving away from its engaged configuration.

6. The firearm of claim 5, further comprising:
a first pin for securing said first magazine release button to said receiver,
wherein moving said first magazine release button between its engaged and disengaged configurations comprises rotating said first magazine release button about said first pin, and
wherein moving said second magazine release button from its disengaged configuration towards its engaged configurations comprises moving said second magazine release button linearly towards said first pin, thereby causing said first magazine release button to rotate away from its disengaged configuration.

7. The firearm of claim 6, further comprising first and second springs in communication with respective first and second magazine release buttons, said first and second springs being configured to bias respective first and second magazine release buttons towards respective disengaged configurations.

8. The firearm of claim 7, wherein each of said first and second magazine release buttons comprises a user engagement member and a flange extending therefrom, respective distal ends of said flanges defining corresponding first and second angled noses.

9. The firearm of claim 8, wherein moving said first release button towards its engaged configuration while said second release button remains in its disengaged configuration causes said first angled nose to rotate away from said second angled nose, and wherein moving said second release button towards its engaged configuration while said first release button is in its disengaged configuration causes said second angled nose to drive into said first angled nose, thereby generating a lateral force biasing said first release button away from its disengaged configuration.

10. The firearm of claim 6, wherein said first and second magazine release buttons are in communication via overlapping of respective first and second angled noses.

11. A magazine release assembly for a firearm, the release assembly comprising:
a magazine catch plate;
a first magazine release button connected to the magazine catch place, wherein said first magazine release button is configured to move rotationally about an axis when engaged, thereby moving said magazine catch plate;
a second magazine release button in communication with said first magazine release button, wherein said second magazine release button is configured to move linearly when engaged.

12. The release assembly of claim 11, wherein said second magazine release button is further configured to impact said first magazine release button upon engagement, thus causing the rotation of said first magazine release button.

13. The release assembly of claim 11, further including a first spring in communication with said first magazine release button and a second spring in communication with said second magazine release button, the first and second spring being configured to return the first and second magazine release buttons to their original positions after being engaged.

14. The release assembly of claim 11, wherein the first and second magazine release buttons each comprise a flange, a distal end of each flange defining an angled nose.

15. The release assembly of claim 14, wherein the first and second magazine release buttons are in communication via overlapping of their respective angled noses.

16. The release assembly of claim 15, wherein said second magazine release button is further configured to impact said first magazine release button upon engagement, thus causing rotating of said first magazine release button.

17. The release assembly of claim 16, further including first spring in communication with the first magazine release button and second spring in communication with the second magazine release button, wherein said first and second springs are configured to return the first and second magazine release buttons to their original positions after being engaged.

18. A method of changing the caliber of a firearm, the firearm comprising:
a receiver body, the receiver body defining a horizontal channel and a mag well extending vertically therefrom; and
a multi-piece trunnion assembly positioned at least partially within said horizontal channel of said receiver body, said multi-piece trunnion assembly comprising:
a trunnion plate engaged with a first bolt head; and
a trunnion block engaged with a first barrel,
wherein the method comprises:
decoupling the trunnion block from the receiver body;
removing the trunnion block from the receiver body while the trunnion plate remains secured to the receiver body;
decoupling the first barrel from the trunnion block;
coupling a second barrel with the trunnion block;
positioning the trunnion block relative to the receiver body and the trunnion plate; and
securing the trunnion block to the receiver body,
wherein the first and second barrels are associated with respective first and second calibers.

19. The method of claim 18, further comprising:
decoupling the trunnion plate of the trunnion assembly from the receiver body;
removing the trunnion plate from the receiver body;
replacing the first bolt head with a second bolt head;
positioning the trunnion plate relative to the receiver body; and
securing the trunnion plate to the receiver body,
wherein the first and second bolt heads are associated with the respective first and second calibers.

20. The method of claim 19, wherein the receiver body is a single piece receiver body formed with additive metal during an additive material process.
